(19) United States
(12) Patent Application Publication
(10) Pub. No.: US 2021/0297374 A1
(43) Pub. Date: Sep. 23, 2021

(54) PROCESS FOR PERSONALIZING AN ELECTRONIC GREETING WITH A VOICE MESSAGE

(71) Applicant: Gary Forster, Tarzana, CA (US)

(72) Inventor: Gary Forster, Tarzana, CA (US)

(21) Appl. No.: 17/205,402

(22) Filed: Mar. 18, 2021

Related U.S. Application Data
(60) Provisional application No. 62/991,923, filed on Mar. 19, 2020.

(51) Int. Cl. H04L 12/58; G06F 3/16; G10L 15/08; G10L 13/00

(52) U.S. Cl. CPC H04L 51/10; G06F 3/16; H04L 51/08; G10L 13/00; G10L 15/08

(57) ABSTRACT

A process for personalizing an electronic greeting includes remotely connecting with a website and selecting a greeting card or song from a library of electronic greetings. One or more personalized audio messages are created or selected. The personalized audio messages are associated with the selected electronic greeting. The electronic greeting with the personalized audio message is then transmitted to at least one recipient.

### RELATED APPLICATIONS

This application claims the benefit of U.S. Provisional Application No. 62/991,923, filed on Mar. 19, 2020.

### FIELD OF THE INVENTION

The present invention generally relates to greetings, including greeting cards and musical songs. More particularly, the present invention relates to a process for personalizing an electronic greeting, in the form of a greeting card and/or song, with a personalized voice message.

### BACKGROUND OF THE INVENTION

In the past, the most common way of sending messages to others for special occasions was by sending a greeting card. One could buy greeting cards relating to birthdays, Christmas, New Years, anniversaries and the like. Such greeting cards included a preprinted message on or in the card to convey thoughts and sentiments. Some greeting cards were designed so as to play music or a portion of a song when the card is opened. The greeting cards were mailed or delivered in person to the intended recipient.

More recently, with the advent of the internet, there are websites which offer digital greeting cards. These greeting cards mimic the older paper cards and typically include a preprinted message. Instead of mailing or delivering the card in person, the user can select the card and email the card or a link to the loved one or other recipient.

There is a continuing need to personalize such greetings which can be done conveniently over the internet so as to include a personalized audible message from the giver to the recipient with either an electronic greeting card or a song. The present invention fulfills these needs, and provides other related advantages.

### SUMMARY OF THE INVENTION

The present invention resides in a process for personalizing an electronic greeting. An electronically accessible website is provided. The website has a library of electronic greetings comprising musical songs and/or greeting cards. These songs and greeting cards are categorized.

A user remotely electronically connects with the website via a computer network. The user searches for a song or electronic greeting card, such as by selecting a category or by keyword. The user selects a greeting from the library of electronic greetings. A predefined portion of a song is played when selected by the end user. Alternatively, the electronic greeting card is displayed when selected by the end user.

At least one personalized audio message is then created or selected. The end user may select a prerecorded voice message. Preferably, however, the end user is prompted to record at least one voice message. The at least one personalized audio message is associated with the electronic greeting. This may be by the at least one personalized audio message being associated with a corresponding at least one predefined window before, after and/or overlapping the selected song or electronic greeting card. The personalized voice message may comprise first and second recorded voice messages having a predefined time limit. The first recorded voice message is inserted in a predefined window before the song and the second recorded voice message is inserted into a predefined window after the song.

Electronic delivery information is provided. This may be an email address or cellphone number for at least one recipient. The end user may be charged according to the number of recipients the electronic greeting and personalized message is to be electronically transmitted to. Then, the electronic greeting, with the at least one personalized audio message, is transmitted to the at least one recipient. A royalty to a rights holder may be automatically paid for the electronic greeting that is transmitted to the recipient.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagram illustrating a system for personalizing an electronic greeting, in accordance with the present invention;

FIG. 2 is a block diagram illustrating components of an end user electronic device used in connection with the system of the present invention;

FIG. 3 is a block diagram illustrating components of a service provider electronic device, in accordance with the present invention;

FIG. 4 is a flow chart depicting the steps taken by a service provider to set up the system in connection with the present invention; and

FIG. 5 is a flow chart depicting the steps of personalizing and transmitting an electronic greeting, in accordance with the present invention.

### DETAILED DESCRIPTION OF THE PREFERRED EMBODIMENTS

As shown in the accompanying drawings, for purposes of illustration, the present invention is directed to a system and process for personalizing an electronic greeting, such as a musical song and/or an electronic greeting card, so as to associate a personalized audio message with the greeting and transmit it to one or more desired recipients. The present invention replaces the increasingly obsolete printed greeting cards, which have become expensive to purchase and mail. The present invention also enables a greater degree of personalization than is currently available with electronic greeting cards, and is particularly suited for creating and sending a personalized electronic greeting in the form of a song having a personalized audio message associated with the song.

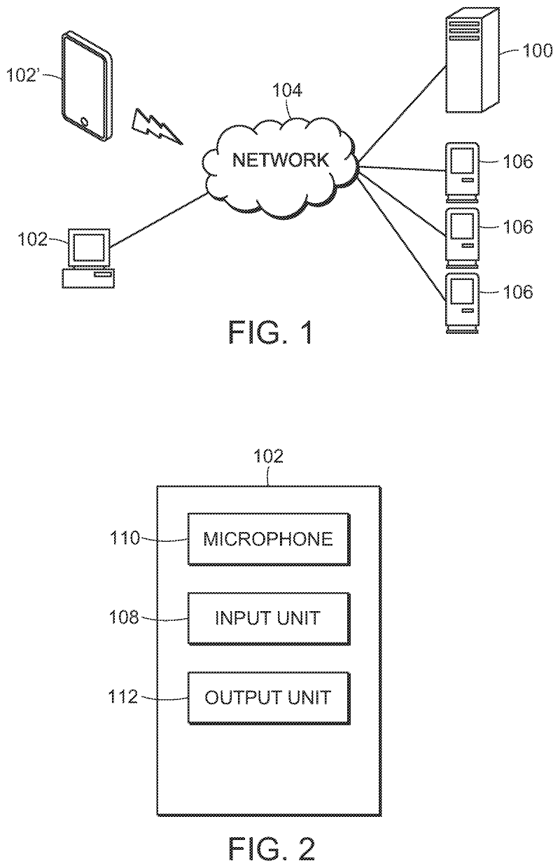

With reference now to FIG. 1, a diagram is provided which illustrates a system embodying the present invention for personalizing an electronic greeting and transmitting it to others. In accordance with the present invention, a website or other interface is electronically accessible via a provider's server or other computer or electronic device 100. The one or more servers or computers or the like of the provider store a library of electronic greetings, typically comprising musical songs and/or electronic greeting cards. The provider's server or computer 100 has electronic memory for storing such information, as well as the necessary electronic components and systems for communicating electronically and remotely with others and performing the present invention, as will be more fully described herein.

End user electronic devices 102 interface or communicate with the provider's website and server or computer 100 through a communications network 104, such as the internet or the like. The end user's electronic device 102 may comprise a desktop, laptop or the like which has a wired connection to the network 104. Alternatively, the end user's electronic device 102′ may comprise a smartphone, tablet, or other computerized electronic device, which is wirelessly connected to the network 104, and thus able to access and interface with the provider's website.

With continuing reference to FIG. 1, in accordance with the present invention, as will be more fully described herein, an end user remotely electronically connects with the provider's website and computer 100 via the computer network 104 and selects a greeting from the library of electronic greetings and creates or selects at least one personalized audio message which is then associated with the selected electronic greeting and electronically transmitted to one or more recipients. The one or more recipients receive this personalized electronic greeting via their electronic device 106, which may comprise a computer, laptop, smartphone, tablet, etc. A link or a file representing the personalized electronic greeting is sent from the provider's server or computer 100 through the network 104 and to the recipient's electronic device 106, where the message can be listened to and/or viewed.

With reference now to FIG. 2, the end user's electronic device 102 must have a certain degree of functionality in order to accomplish the present invention. The end user's computer 102 includes an input unit 108, for receiving information from the provider's computer 100, such as in the form of the website which conveys information to the end user. The end user's computer 102 will also have an electronic display screen for viewing the website and other information and inputting or selecting information, such as including a keyboard, touchscreen, mouse or the like wherein information can be input or selected via the provider's website. The end user's electronic device 102 also includes a microphone 110 for creating the personalized audio message by the end user. The invention contemplates, however, that if the end user's electronic device 102 does not include a microphone that provisions may be made, such as by providing a telephone number which the end user can call and leave one or more personalized messages via a voice recording, to be later compiled and associated with the electronic greeting. The end user device 102 also includes an output unit 112, such as for downloading or transmitting information to the provider's server or computer 100, such as a recorded audio message, selections and the like.

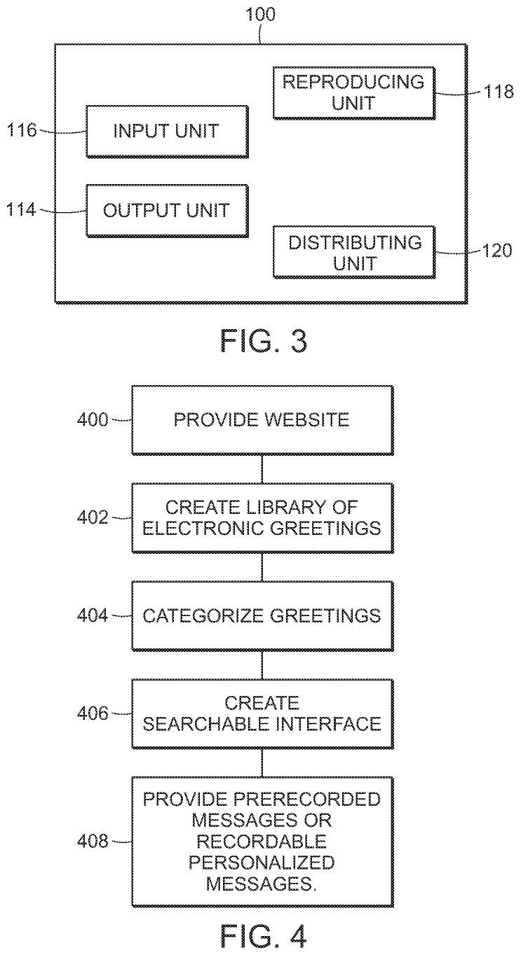

With reference now to FIG. 3, the provider's one or more servers or computers 100 include an output unit 114, such as in order to output the information conveyed by the provider, such as via a website or the like. The provider's server or computer includes an input unit 116, which will receive information provided by the end user, such as what the end user has input or selected via the website, downloaded or included with respect to audio voice messages and the like. The provider's server or computer 100 also includes a reproducing unit 118 which takes the selected electronic greeting, in the form of a musical song or electronic greeting card, and associates the selected or created personalized audio message with the electronic greeting. The personalized electronic greeting is then transmitted to one or more recipients through a distributing unit 120 of the computer 100.

With reference now to FIG. 4, the provider creates and provides an interface with end users, typically in the form of an electronically accessible website (400). The provider creates a library of electronic greetings (402). The electronic greeting may comprise electronic greeting cards, but more typically will include a library of musical songs. It is contemplated by the present invention that both electronic greeting cards and musical songs could be offered.

In accordance with the present invention, the greetings are categorized (404). For example, such greetings could be characterized under the categories of love, gratitude or being thankful, getting well or sympathy, congratulations, or apologies or being sorry. The categories could also include aspects of one's life to celebrate, such as birthdays, anniversaries, weddings and engagements, graduations, or pregnancies or births of babies or the like. Such electronic greetings could also be categorized according to holidays, such as Christmas, New Years, Easter, Mother's Day, Father's Day, Independence Day, Thanksgiving, Hanukkah, Valentine's Day, St. Patrick's Day, and Halloween. Such greetings could also be characterized according to gender, so as to be directed to “him” or “her”, “husband”, “wife”, etc. Categories for songs could be similarly categorized as noted above, or also be categorized by musical genre, artist, time period of the song and the like.

With continuing reference to FIG. 4, the provider also creates a searchable interface (406) so that the end user can easily find an appropriate song or greeting to select. The end user may find and select this greeting by selecting one or more categories and subcategories and narrowing the selection in this manner. The invention also contemplates that the end user may enter keywords such as a title, artist, or the like for finding the desired electronic greeting.

The service provider may provide prerecorded messages which can be selected by the end user or means for recording personalized messages (408). For example, short audio messages may be prerecorded, listened to, and selectable by the end user to include in the electronic greeting. Such prerecorded messages may be by actors, athletes, or other well-known and famous people or even the artist of the song. More typically, however, the end user is the one who records the at least one personalized audio message to be associated with the electronic greeting. This may be by means of the end user selecting a record button on a website and recording a short audio message to be associated with the electronic greeting. The audio recording is captured via the website and stored for later processing. Alternatively, an audio file containing the end user's audio message may be uploaded to the service provider via the website or other means. As yet another alternative, as mentioned above, the end user, such as one not having a microphone associated with his or her electronic device, may call a telephone number and leave one or more audio voice messages to be included in the electronic greeting.

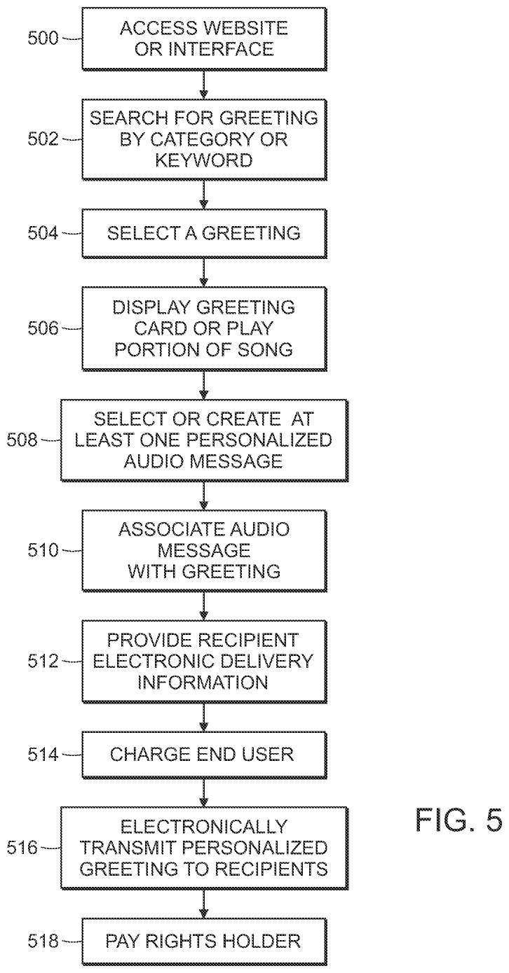

With reference now to FIG. 5, a flow chart depicting the steps taken in accordance with the present invention in order to select, create and transmit a personalized electronic greeting are shown. The end user accesses the provider's website or interface (500). As mentioned above, this is typically done remotely, such as via the internet or other communications network 104. The website may or may not include a subscription, but preferably does not include a subscription so that anyone can access and use the website. The interface may alternatively comprise a software application which is downloaded onto the electronic device, such as on the smartphone, tablet, or the like of the end user. The website or interface may or may not include plugins or other software programs uploaded to the internet cloud of the website and accessible or downloaded or uploaded onto the end user's electronic device. In a particularly preferred embodiment, the website or software app does not require registration or subscription, so as to be available to anyone to browse and use.

The end user then searches for a greeting, such as by category or keyword (502). The website or interface may display various categories for the end user to select, such as birthdays, sentimental/love, Christmas greeting, New Year's greeting, get well message, etc. Categories of songs may also be displayed, such as by genre (classical, rock, rap, etc.), time period, artist, etc. In this manner, the end user may be easily able to narrow a potential set of electronic greeting cards or musical songs to be selected from by choosing one or more of these categories and/or subcategories. Additionally, or alternatively, the end user may be able to conduct a keyword search, such as when the end user knows a title of a desired song, a desired artist or band, or knows certain words of a song and which the end user inputs to search the library and database of the electronic greeting instead of by category.

The end user then selects a greeting (504), after which a greeting card representing the selection is displayed or a portion of the selected song may be played for the end user (506), such as a five-second identifying portion of the song. In this manner, the end user can see the electronic greeting card before making a final selection or hear a small portion of the song to confirm that the song is what the end user wishes to select and use for the personalized electronic greeting.

The invention contemplates that musical songs are many times the memories of our lives. Selecting a song may be used to bring up a memory, special moment, or anything personal which the end user wishes to convey to a recipient. Alternatively, the song may evoke an emotion, convey a sentiment or message or the like.

After selecting the desired greeting, the end user is then given the option to either select a prerecorded personalized audio message, or more typically create at least one personalized audio message by the end user (508). In such case, the end user is prompted to record at least one voice message. In a particularly preferred embodiment, at least two voice messages are recorded, each having a defined time limit. For example, the end user may be given a period and time limit of less than five seconds or up to ten seconds to record an audio message. The end user may hit the “record” button, and be shown a clock or timer showing the amount of time remaining for the end user to record that audio message.

The one or more audio messages are then associated with the greeting (510). The at least one personalized voice message is associated with the greeting, such as corresponding with at least one predefined window which may be before, after and/or overlapping the selected song or electronic greeting card. The personalized voice message may comprise first and second recorded voice messages by the end user, each having a predefined time limit. The first recorded voice message is inserted into a predefined window before the song and the second recorded voice message is inserted into a predefined window after the song. As each song is different, the provider may designate one or more distinct points where it would be best to insert the one or more personalized messages.

By way of example, an end user knows his wife has a favorite sentimental song when he was in the army in 1952-1953. The song is “I'll be Home for Christmas” by Bing Crosby. As described above, the end user may search for this song under various categories, such as sentimental, Christmas, time period, or keyword such as title, name of artist, etc. It will be appreciated that some songs can overlap categories and thus be categorized in multiple categories. When the end user finds the desired song, a small portion, such as five to ten seconds of the song is played for the end user to confirm that this is the song he or she desires to use.

The end user is then prompted to make one or more short audio recordings. For example, the first may be labeled number one for 5-10 seconds and the second labeled number two for 5-10 seconds, or whatever predefined time period the provider defines. When the end user selects the first record button, he may say “Hi Dee, this is your beloved Hal and this song should take you back to 1952, which was a favorite of yours”. For the second record prompting, the end user will once again record his or her voice, Such as “This song kept me warm in frozen barracks every night just thinking of you. Love you, Hal”.

The end user may be able to listen to his or her recordings, and rerecord them as desired. The recordings and the song may also be played for the end user for approval. For example, the first recording may be added immediately before the song or the beginning of the song may have its music and volume lowered so that the voice is elevated with respect to the music so the recipient can easily hear it. Immediately after the song or towards the end of the song, the second preprogrammed and predefined window has the second message inserted therein. The user's voice may fade and the rest of the song elevated to play to the end of the song, as an example. Alternatively, the end user's personalized message may be played after the song. The end user may then be prompted whether to accept or to rerecord the audio messages. If it is unacceptable, the end user may record it again. If the recording is accepted, the process with respect to creating the personalized greeting is complete.

The end user then provides recipient electronic delivery information (512). This may be the electronic delivery information, which may comprise an email address or cellphone number, of at least one recipient. The end user may send the personalized electronic greeting to one recipient or more than one recipient. For example, an end user may send a very sentimental and personalized greeting to his or her spouse, boyfriend or girlfriend, etc. where it is only sent to that one recipient. In other occasions, the end user may wish to send the personalized greeting to multiple recipients, such as when wishing various coworkers, family members or the like a Merry Christmas.

The end user is then charged a fee (514). The fee may be based upon the song or greeting card selected, the number of recipients that the personalized greeting is to be transmitted to, the number or length of the personalized audio messages used by the end user, etc. For example, the end user may be charged $4.95 for creating and delivering a single personalized electronic greeting. However, for the cost of $9.95 the end user may be able to send the personalized electronic greeting up to a predefined number of recipients, such as five recipients. For a higher charge, the number of recipients may be increased.

After approval and payment, the personalized greeting is then electronically transmitted and delivered to the one or more recipients (516). This may be in the form of an email or text message or the like and which contains the entirety of the personalized greeting. In other cases, a link may be provided to the recipient to access the personalized greeting, such as through the provider's website.

The rights holder, such as the individual, group of individuals or company owning the copyright or other intellectual property rights in the greeting, is then paid (518). The identity and related information of the rights holder may be linked to each song and/or electronic greeting card such that a predefined royalty amount is automatically paid to the rights holder once that song or greeting card is used and transmitted to the one or more recipients. The royalties may be mechanical royalties which have been established by the United States government or royalties agreed to by the artist, publisher or the like. In other cases, there may not be a need to pay a royalty.

Although several embodiments have been described in detail for purposes of illustration, various modifications may be made without departing from the scope and spirit of the invention. Accordingly, the invention is not to be limited, except as by the appended claims.

What is claimed is:

1. A process for personalizing an electronic greeting, comprising the steps of:
providing an electronically accessible website having a library of electronic greetings;
remotely electronically connecting with the website via a computer network and selecting a greeting from the library of electronic greetings;
creating or selecting at least one personalized audio message;
associating the at least one personalized audio message with the selected electronic greeting;
providing electronic delivery information for at least one recipient; and
transmitting the electronic greeting with the at least one personalized audio message to the at least one recipient.

2. The process of claim 1, wherein the electronic greetings comprise musical songs and/or electronic greeting cards.

3. The process of claim 2, wherein the songs and/or electronic greeting cards are categorized.

4. The process of claim 3, wherein an end user searches for a song or electronic greeting card by category or by keyword.

5. The process of claim 4, including the step of playing a predefined portion of a song when selected by the end user.

6. The process of claim 4, including the step of displaying the electronic greeting card when selected by the end user.

7. The process of claim 4, wherein the step of creating or selecting a personalized audio message comprises the end user selecting a prerecorded voice message.

8. The process of claim 4, wherein the step of creating or selecting a personalized audio message comprises the end user being prompted to record at least one voice message.

9. The process of claim 2, wherein the associating step comprises the step of associating the at least one personalized voice message with a corresponding at least one predefined window before, after, and/or overlapping the selected song or electronic greeting card.

10. The process of claim 9, wherein the personalized voice message comprises first and second recorded voice messages having a defined time limit, the first recorded voice message being inserted in a predefined window before the song and the second recorded voice message being inserted into a predefined window after the song.

11. The process of claim 1, wherein the step of providing electronic delivery information comprises providing an email address or cell phone number of at least one recipient.

12. The process of claim 1, including the step of charging an end user according to the number of recipients the electronic greeting and personalized message is to be electronically transmitted to.

13. The process of claim 1, including the step of automatically paying a royalty to a rights holder of the electronic greeting that is transmitted to a recipient.

14. A process for personalizing an electronic greeting, comprising the steps of:
providing an electronically accessible website having a library of categorized electronic greetings comprising musical songs and/or greeting cards;
remotely electronically connecting with the website via a computer network and searching for a song or electronic greeting card by category or by keyword;
selecting a greeting from the library of electronic greetings;
creating or selecting at least one personalized audio message;
associating at least one personalized audio message with a corresponding at least one predefined window before, after and/or overlapping the selected song or electronic greeting card;
providing electronic delivery information for at least one recipient; and
transmitting the electronic greeting with the at least one personalized audio message to the at least one recipient.

15. The process of claim 14, wherein the personalized voice message comprises first and second recorded voice messages having a defined time limit, the first recorded voice message being inserted in a predefined window before the song and the second recorded voice message being inserted into a predefined window after the song.

16. The process of claim 14, including the step of playing a predefined portion of a song when selected by the end user or displaying the electronic greeting card when selected by the end user.

17. The process of claim 14, wherein the step of creating or selecting a personalized audio message comprises the end user selecting a prerecorded voice message or the end user being prompted to record at least one voice message.

18. The process of claim 14, including the steps of:
providing electronic delivery information comprises providing an email address or cell phone number of at least one recipient;
charging an end user according to the number of recipients the electronic greeting and personalized message is to be electronically transmitted to; and
automatically paying a royalty to a rights holder of the electronic greeting that is transmitted to a recipient.

19. A process for personalizing an electronic greeting, comprising the steps of:
providing an electronically accessible website having a library of categorized electronic greetings comprising musical songs and/or greeting cards;
remotely electronically connecting with the website via a computer network and searching for a song or electronic greeting card by category or by keyword;
selecting a greeting from the library of electronic greetings;
playing a predefined portion of a song when selected by an end user or displaying the electronic greeting card when selected by the end user;
creating or selecting at least one personalized audio message, including the end user selecting a prerecorded voice message or the end user being prompted to record at least one voice message;
associating at least one personalized audio message with a corresponding at least one predefined window before, after and/or overlapping the selected song or electronic greeting card;
providing electronic delivery information comprising an email address or cell phone number for at least one recipient;
charging the end user according to the number of recipients the electronic greeting and personalized message is to be electronically transmitted to;
transmitting the electronic greeting with the at least one personalized audio message to the at least one recipient; and
automatically paying a royalty to a rights holder of the electronic greeting that is transmitted to a recipient.

20. The process of claim 19, wherein the personalized voice message comprises first and second recorded voice messages having a defined time limit, the first recorded voice message being inserted in a predefined window before the song and the second recorded voice message being inserted into a predefined window after the song.
